(19) United States
(12) Patent Application Publication
(10) Pub. No.: US 2011/0179036 A1
(43) Pub. Date: Jul. 21, 2011

(54) Methods and Apparatuses For Abstract Representation of Financial Documents

(76) Inventors: Jason Townes French, Sunnyvale, CA (US); Auston John Stewart, Hilo, HI (US)

(21) Appl. No.: 12/970,936

(22) Filed: Dec. 16, 2010

Related U.S. Application Data
(60) Provisional application No. 61/287,086, filed on Dec. 16, 2009.

(51) Int. Cl. G06F 17/30

(52) U.S. Cl. 707/739; 707/E17.089

(57) ABSTRACT

Systems and methods are provided for creating abstracted, normalized, and reuseable and combinable representations of information contained in multiple documents and information of any supported format, and allowing for exporting of information in any other desired and supported format. Further the system and methods provide for uploading documents based on a known template, where the data members can be automatically recognized and the document stored in normalized format without end-user or developer intervention. Normalization of data is achieved transparently on upload and denormalization performed transparently on download. Further, embodiments provide for the reuse and recombination of data members to create entirely new representations.

### CROSS-REFERENCE TO RELATED APPLICATIONS

The present application claims priority from U.S. Provisional Application Ser. No. 61/287,086 filed Dec. 16, 2009, which is incorporated herein by reference in its entirety for all purposes.

### FIELD OF THE INVENTION

The present invention relates generally to computerized information display and input, and more particularly to methods and apparatuses for creating abstracted, normalized, and reuseable and combinable representations of information contained in received financial documents (and documents in general) and information of any supported format, and allowing for exporting of information in any other desired and supported format.

### BACKGROUND OF THE INVENTION

Conventional techniques for managing information such as information in financial documents have several shortcomings. For example different companies may chose to represent their data in different file formats, this introduces a problem when a third party tries to compare or analyze all of the company's data in tandem. In such circumstance, for example to create comparisons and graphical representations of financial data across companies it is necessary for that data to be stored, at least temporarily, in a single, normalized format. Converting the original file formats to a single format can be cumbersome because individual companies store their financial data in a variety of open and proprietary normalized formats, as well as non-normalized file formats such as the Portable Document Format (PDF) and Microsoft Excel Spreadsheet (XLS). A need, therefore, exists for simplified importing and exporting of financial data in various formats to facilitate normalization of that data while allowing companies contributing information to continue use of their preferred formats. Embodiments of the present invention provide novel streamlined systems and methods of converting the desired input files or file formats to a common format to simply the analysis and provides for reuse and recombination of data members obtained from the files.

### SUMMARY

The embodiments of the present invention relate generally to software applications including network-enabled applications According to some aspects, the embodiments of the invention add a layer of abstraction to the storage and retrieval of financial data such that those functions, when applied to financial documents represented by normalized data in a data store or relational database, are programatically equivalent to typical uploading and downloading of non-normalized file data. When implemented as a software library, embodiments of the invention free developers from consideration of the internal representation of a financial document when allowing a user to operate on a document, as each document, identified by a unique ID, may be presented in any supported document format as a data blob with appropriate header information. According to further aspects, when a user uploads a document based on a known template, the data members can be automatically recognized and the document stored in normalized format without end-user or developer intervention, although uploaded file may be in Excel, PDF, Word, OpenDoc, or other format. Thus normalization of data is achieved transparently on upload and denormalization performed transparently on download. Further, the embodiment provide for the reuse and recombination of data members to create entirely new representations.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating one method according to example implementations of embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the FIGURE and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration. For ease of understanding, the embodiments of the present invention are described in network-enabled applications for the processing of financial data. Such is not intended to be a limitation on the embodiments of the present invention and any form of scalar or vector data is contemplated within the scope of the embodiments.

In general, the embodiments of the invention relate to a document system that adds a layer of abstraction to the storage and retrieval of financial data such that those functions, when applied to financial documents represented by normalized data in a data store or relational database, are programmatically equivalent to typical uploading and downloading of non-normalized file data. This frees end-users and developers from consideration of the internal representation of a financial document when allowing a user to operate on a document, as each document, identified by a unique ID, may be presented in any supported document format as a data blob with appropriate header information. According to further aspects, when a user uploads a document based on a known template, the data members can be automatically recognized and the document stored in normalized format without developer intervention, although uploaded file may be in Excel, PDF, Word, OpenDoc or other format. Thus normalization of data is achieved transparently on upload and denormalization performed transparently on download.

The system and methods presented herein provide novel means of storing data obtained during an import process such that it can be used in unlimited subsequent compositions and representations of the data.

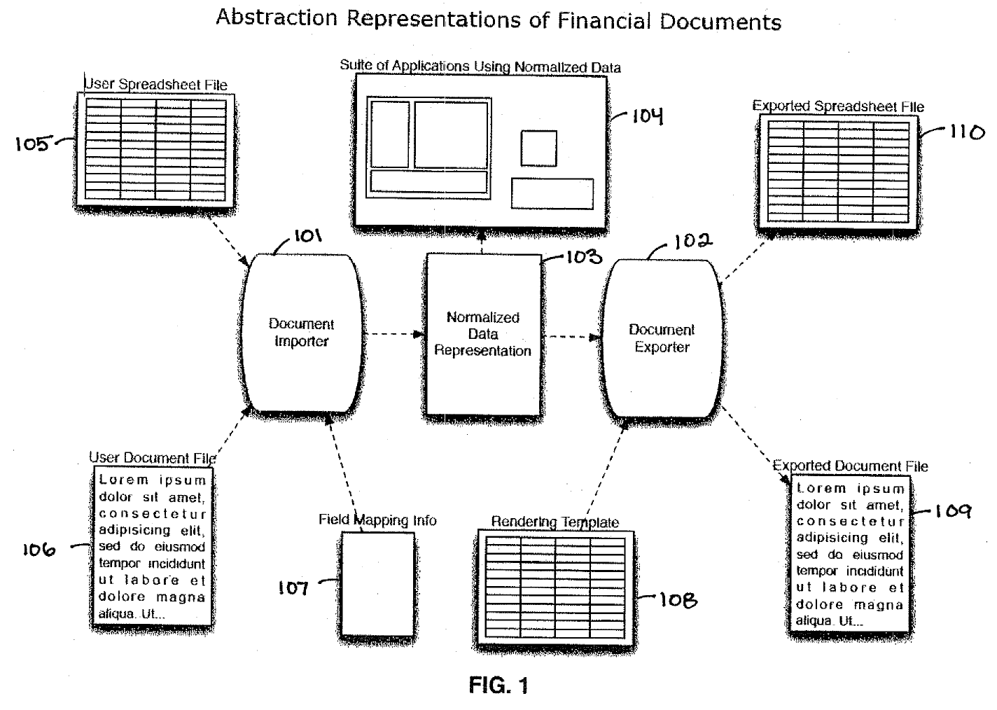

FIG. 1 is a block diagram illustrating an example implementation of embodiments of the invention.

As shown in FIG. 1, a system 100 for implementing features of the embodiments of the invention include a document importer 101 and document exporter 102. In one embodiment, the document importer 101 may be software for processing an input file and identifying categories of data contained therein. In one embodiment, the document exporter may be software for extracting data from a data store and encoding it for an intended file format. The document importer 101 creates normalized data from imported documents 105, 106 that may be stored in a data store and easily referred to by a tag, such as a semantic tag. The document exporter 102 creates and/or recreates documents 109, 110 in particularized formats from the normalized data. Although only one document importer, normalized data database, and document exporter are shown, it should be apparent that there can be many of one or all, implemented as software processes executing on one or more computers. It should be further apparent that they can be distributed across different computers on a public or private network, and can communicate with public or private protocols. Further although depicted with multiple documents imported and exported, such is not intended to be a limitation on the embodiments of the present invention and it is contemplate that one or more documents may be imported or exported.

In one embodiment, the importer responds to input from a user. For example, when reading in a filing containing data delimited by a specific character, a graphical user interface can be displayed to allow the user to define a label, category or tag for the data. In another embodiment, the importer, automatically without user interference executes a deterministic process to process the input file or data according to a discrete set of rules.

In one embodiment, the system further includes applications 104 where previously imported, stored and tagged data can be readily accessed, for example by tag.

In embodiments, the document importer 101 inserts financial data into a database 103 accommodating normalized storage of the data members, which may be tagged, of each supported financial document, but whose structure is unrelated to that of said documents. For instance, it may be the case that two different supported financial documents have elements (for instance, a 2009 Fall Quarter Net Revenue figure) that map to the same database field. Relevant financial data for each company is aggregated through the normalization of data extracted from supported documents for use in comparisons and visualizations of data across any number of companies. Examples of this feature are described below.

In operation of embodiments of the invention, the document importer uses field mapping information 107 giving the locations of specific data members or groups of data members within known template-based documents to extract raw financial figures from files in various non-normalized formats In another embodiment a template based document is any document that can have its data defined separately from its structure, i.e. an Excel file, an XBRL file, a QuickBooks worksheet, a PDF fill form. These raw figures are then inserted into a normalized, relational database in such a way as to facilitate comparisons and visualizations of multiple companies' data. The data as stored in the database is considered to be in ‘abstract’ format. This includes “smart” conversions of, for example, date ranges and reporting periods, into consistent form, to permit more appropriate and effective comparisons.

In one embodiment, the suite of applications 104 can make use of the permissions governing read, write and list access privileges for the imported data provided by the operating environment. For example, the network-driven operating system described in co-pending provisional application entitled Network-Driven Multi-Processing Distributed Operating System [FOS-002, filed Jan. 14, 2010], attached hereto as Appendix A. which is incorporated herein in its entirety for all purposes. Privileges may be granted to users and groups of users either directly or upon acceptance of legal agreements administered by the system. Access to certain data, such as financial figures, either directly or through exported documents can therefore be subject to such restrictions as a security precaution.

As shown, a suite of applications 104 can also use the normalized data in its normalized form. For example, there can be a “Portfolio Comparisons” application in which, for a given portfolio of companies, any individual or combination of financial values may be compared. For instance, a user may compare and graph Net Revenues for ten companies in which he holds shares over the last five years. As another example, there can be a “Valuation Tools” set of applications. Here, financial figures imported into the normalized database can be used to generate rough valuations for the companies with sufficient information on file. Valuations of various companies within and across sectors may be compared. These financial values are referenced directly from the data store and need not be explicitly managed or updated in each instance of the value, but rather in its singular representation in the data store.

When a document backed by normalized company data, such as an Income Statement, is requested from the document system, a desired output format may be rendered by the document exporter 102 in conjunction with a rendering template 108, which governs the encoding process. This allows a developer to deliver any supported document to a user in the format of their choice, and be re-delivered in the same or any other supported format. Equivalent documents in formats such as PDF, Word, Excel, OpenDoc and other formats can all be generated directly from normalized data through this system.

It should be noted that as documents represented by normalized data stored in the normalized data store 103 may share information between them either directly or through calculations, if new financial data is uploaded and normalized for one document that affects shared and calculated numbers in other documents, the figures in those documents are updated automatically. This sharing eliminates duplicity and stale data while ensuring consistency across any documents or applications referencing the normalized or abstracted data. For example, when a new document is imported that updates existing normalized financial data for a company, that change is immediately reflected in any application making use of that data as well as in subsequently exported documents that reference it. For example, if a revised Income Statement for Fall Quarter 2009 is imported for Company X that changes the Net Revenue figure for that period, a user comparing the Net Revenues of various companies, including Company X, will immediately see the change. If another user subsequently exports Summary Financials 2009 document for Company X, the updated figure will be present there as well.

Furthermore, due to the fact that all data members from all imported data files are stored in a single and centralized data store, the conversion of document is not constricted to a one to one basis in that the data obtained from converting one document can be used to create multiple document and similarly the data obtained from converting multiple documents can be represented in a single document. The novel system and method presented herein provides for unlimited subsequent representations of the abstracted data including representations whose structures differ dramatically from the structure of the data when it was importer.

Although the present invention has been particularly described with reference to the preferred embodiments thereof, it should be readily apparent to those of ordinary skill in the art that changes and modifications in the form and details may be made without departing from the spirit and scope of the invention. It is intended that the invention encompass such changes and modifications.

1. A method for exchanging data comprising:
obtaining at least one input file;
identifying categories of information contained within the at least one input file;
extracting the information contained within the at least one input file, wherein the extracted information is stored in a normalized format in a datastore according to the identified categories;
encoding the normalized data into a specified file format;
transmitting data in the specified file format;
tagging the extracted information; and
using the tagged extracted information to identify semantic values to create a new file.

2. The method of claim 1, wherein identifying categories of information is performed through automated detection of data categories.

3. The method of claim 1, wherein identifying categories of information is performed by receiving input from a user.

4. The method of claim 1, wherein extracting the information contained within the at least
one input file further comprising
identifying a file type
reading data from the file type by implementing a read or write procedure for data contained within a file format.

5. A system for exchanging data comprising:
a document importer module, the document importer module adapted to obtain at least one input file and normalize and identify categories of data from the at least one input file;
a data module, the data module adapted to store the extracted information in a normalized format , wherein the extracted information is stored according to the identified categories;
a document exporter module, the document exporter module adapted to extract the normalized data and use the categories of data to identify semantic values and encode the data in a specified file format.

6. The system of claim 5, wherein the document importer module is adapted to identify categories of information through automated detection of data categories.

7. The system of claim 1, wherein the document importer module is adapted to receive input from a user to identify categories of information.

8. The system of claim 5, wherein extracting the information contained within the at least
one input file further comprising
identifying a file type
reading data from the file type by implementing a read or write procedure for data contained within a file format.

9. The system of claim 5, further comprising a suite of applications wherein an application in the suite of applications accesses the extracted information stored according to the identified categories and provides the information to a user in the user specified format.
